(19) United States
(12) Patent Application Publication
(10) Pub. No.: US 2026/0010350 A1
(43) Pub. Date: Jan. 8, 2026

(54) ELECTRONIC DEVICE AND METHOD WITH APPLICATION MODELING

(71) Applicant: Samsung Electronics Co., Ltd., Suwon-si (KR)

(72) Inventors: Heng KANG, Xi’an (CN); Wei DU, Xi’an (CN); Yuanning BAI, Xi’an (CN); Fengtao XIE, Xi’an (CN)

(73) Assignee: Samsung Electronics Co., Ltd., Suwon-si (KR)

(21) Appl. No.: 19/022,489

(22) Filed: Jan. 15, 2025

(30) Foreign Application Priority Data
Jul. 2, 2024 (CN) 202410882751.4
Oct. 7, 2024 (KR) 10-2024-0135920

(51) Int. Cl. G06F 8/35; G06F 8/30

(52) U.S. Cl. CPC G06F 8/35; G06F 8/37

(57) ABSTRACT

A processor-implemented method includes, based on an execution of a binary file of an application, acquiring dynamic information about an execution process of the binary file, acquiring a call structure for a call relationship between a plurality of functions performed in the execution process of the binary file, based on the dynamic information, and generating skeleton code of the application, based on the call structure for the call relationship between the plurality of functions.

### CROSS-REFERENCE TO RELATED APPLICATIONS

This application claims the benefit under 35 USC § 119 (a) of Chinese Patent Application No. 202410882751.4, filed on Jul. 2, 2024 in the China National Intellectual Property Administration, and Korean Patent Application No. 10-2024-0135920, filed on Oct. 7, 2024 in the Korean Intellectual Property Office, the entire disclosures of which are incorporated herein by reference for all purposes.

### BACKGROUND

### 1. Field

The following description relates to an electronic device and method with application modeling.

### 2. Description of Related Art

A supercomputing architecture design simulator may include several parts, such as hardware modeling, system modeling, application modeling, simulation, and design proposal. Hardware modeling and system modeling may have mature modeling methods, but application modeling may require a large amount of source code analysis and modification due to the complexity of an application (e.g., large-scale coding, various programming languages, and compiler types).

An application modeling method may include a compiler-based application modeling method, a manual application modeling method, a static code analysis-based application modeling method, and a source code-level modification-based application modeling method.

An application modeling method may depend on application source code, and the modeling process of an application may not be reused for other applications. In addition a user may have to manually analyze and/or modify application source code. However, analyzing source code of a large-scale application may be difficult and time-consuming, which may lead to problems of time overhead of application modeling, labor costs, and very high barriers to user entry. That is, when modeling an application using such a method, source code of an application is required, and there may be a problem that a user must manually analyze and/or modify the source code.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes, based on an execution of a binary file of an application, acquiring dynamic information about an execution process of the binary file, acquiring a call structure for a call relationship between a plurality of functions performed in the execution process of the binary file, based on the dynamic information, and generating skeleton code of the application, based on the call structure for the call relationship between the plurality of functions.

The acquiring of the dynamic information may include determining one or more core functions among the plurality of functions, wherein the one or more core functions have a workload exceeding a threshold value, among the plurality of functions, determining whether to call the one or more core functions, setting one or more simulation schedules for the binary file, based on a result of the determining of whether to call the one or more core functions, and generating the dynamic information by executing the binary file in parallel according to the set one or more simulation schedules.

The determining of the one or more core functions among the plurality of functions may include analyzing one or more workloads of the plurality of functions, and determining, to be the one or more core functions, among the plurality of functions, one or more functions of which a workload of the one or more workloads exceeds the threshold value in response to the binary file being executed.

The determining of whether to call the one or more core functions may include, in response to calling a first core function, which is one of the one or more core functions, determining, among the one or more core functions, not to call another core function except for the first core function.

The setting of the one or more simulation schedules may include, in response to calling the first core function and not calling the other core function except for the first core function, generating a first simulation schedule configured to maintain an execution of the first core function and configured to block an execution of the other core function except for the first core function.

The blocking of the execution of the other core function may be performed through a wrapper library.

The blocking of the execution of the other core function may include hijacking the other core function based on a hijacking function of the wrapper library.

The generating of the dynamic information by executing the binary file in parallel may include generating the dynamic information by performing dynamic binary analysis (DBA) on a result obtained by executing the binary file in parallel.

The acquiring of the call structure for the call relationship between the plurality of functions may include parsing the dynamic information, and generating a tree diagram representing the call structure for the call relationship between the plurality of functions during the execution of the binary file, based on a result obtained by parsing the dynamic information.

The generating of the skeleton code of the application may include generating the skeleton code for each layer according to a language that is designated for the application, based on the tree diagram representing the call structure for the call relationship between the plurality of functions.

In one or more general aspects, an electronic device includes one or more processors configured to, based on an execution of a binary file of an application, acquire dynamic information about an execution process of the binary file, acquire a call structure for a call relationship between a plurality of functions performed in the execution process of the binary file, based on the dynamic information, and generate skeleton code of the application, based on the call structure for the call relationship between the plurality of functions.

For the acquiring of the dynamic information, the one or more processors may be configured to determine one or more core functions among the plurality of functions, wherein the one or more core functions have a workload exceeding a threshold value, among the plurality of functions, determine whether to call the one or more core functions, set one or more simulation schedules for the binary file, based on a result of the determining of whether to call the one or more core functions, and generate the dynamic information by executing the binary file in parallel according to the set one or more simulation schedules.

For the determining of the one or more core functions among the plurality of functions, the one or more processors may be configured to analyze one or more workloads of the plurality of functions, and determine, to be the one or more core functions, among the plurality of functions, one or more functions of which a workload of the one or more workloads exceeds the threshold value in response to the binary file being executed.

For the determining of whether to call the one or more core functions, the one or more processors may be configured to, in response to calling a first core function, which is one of the one or more core functions, determine, among the one or more core functions, not to call another core function except for the first core function.

For the setting of the one or more simulation schedules, the one or more processors may be configured to, in response to calling the first core function and not calling the other core function except for the first core function, generate a first simulation schedule configured to maintain an execution of the first core function and configured to block an execution of the other core function except for the first core function.

The blocking of the execution of the other core function may be performed through a wrapper library.

The blocking of the execution of the other core function may include hijacking the other core function based on a hijacking function of the wrapper library.

For the generating of the dynamic information by executing the binary file in parallel, the one or more processors may be configured to generate the dynamic information by performing dynamic binary analysis (DBA) on a result obtained by executing the binary file in parallel.

For the acquiring of the call structure for the call relationship between the plurality of functions, the one or more processors may be configured to parse the dynamic information, and generate a tree diagram representing the call structure for the call relationship between the plurality of functions during the execution of the binary file, based on a result obtained by parsing the dynamic information.

For the generating of the skeleton code of the application, the one or more processors may be configured to generate the skeleton code for each layer according to a language that is designated for the application, based on the tree diagram representing the call structure for the call relationship between the plurality of functions.

Other features and aspects will be apparent from the following detailed description, the drawings, and the claims.

### BRIEF DESCRIPTION OF THE DRAWINGS

FIG. 1 illustrates an example of performing application modeling by providing application modeling information through a dynamic binary analysis (DBA) framework.

FIG. 2 illustrates an example of accelerating a DBA process by performing function-level modeling at a high speed through a wrapper library.

FIG. 3 illustrates an example of a hijacking function in a wrapper library.

FIG. 4 illustrates an example of a translation tool.

FIG. 5 illustrates an example of an application modeling apparatus.

FIG. 6 illustrates an example of an application modeling method.

FIG. 7 illustrates an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

In connection with the description of the drawings, like reference numerals may be used for similar or related components. It is to be understood that a singular form of a noun corresponding to an item may include one or more of the things, unless the relevant context clearly indicates otherwise.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms used herein including technical or scientific terms have the same meaning as commonly understood by one of ordinary skill in the art to which this disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Hereinafter, examples will be described in detail with reference to the accompanying drawings. When describing the examples with reference to the accompanying drawings, like reference numerals refer to like elements and a repeated description related thereto will be omitted.

A typical application modeling method necessarily requires application source code. However, the application source code has a problem in that the application source code complicates a typical modeling process due to the complexity and diversity and may not be reused for other applications.

In the present disclosure, dynamic binary analysis (DBA) technology of an electronic device and method of one or more embodiments may replace a process of analyzing source code with the extraction of dynamic information during the execution of a binary file of an application, thereby providing an integrated and source code-independent application modeling method.

A typical DBA process may have an extremely large time overhead. In the present disclosure, however, a solution for reducing the DBA time overhead of an electronic device and method of one or more embodiments may significantly shorten the application modeling time.

A translation tool provided herein may perform application modeling by generating pieces of skeleton code of an application with various types of language, using information output through DBA.

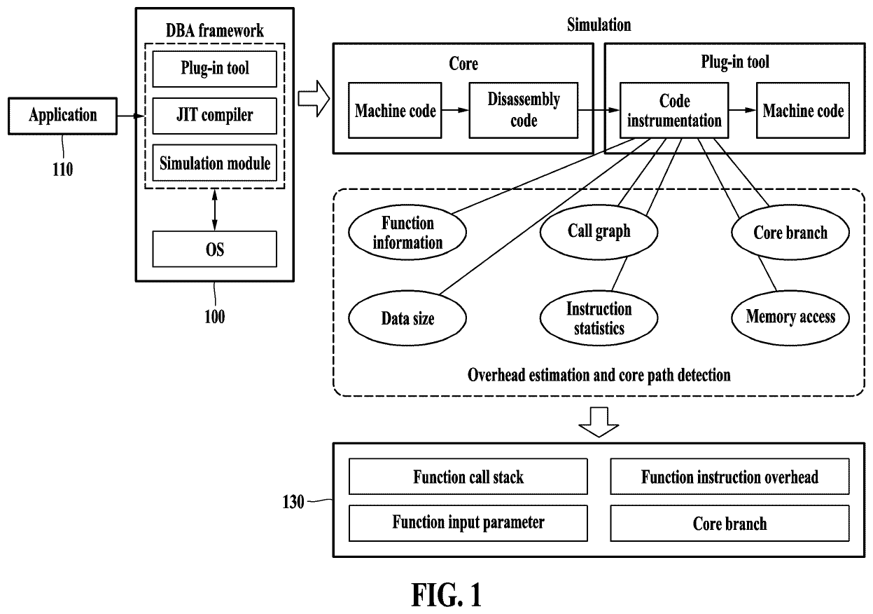

FIG. 1 illustrates an example of performing application modeling by providing application modeling information through a dynamic binary analysis (DBA) framework.

Referring to FIG. 1, an electronic device 100 may acquire (e.g., determine and/or generate) dynamic information 130 by performing DBA on an application 110. The electronic device 100 may include a DBA framework and an operating system (OS) to perform DBA.

The electronic device 100 may execute a binary file (e.g., a binary program) of the application 110 through the DBA framework. The electronic device 100 may acquire the dynamic information 130, based on the execution of the binary file of the application 110.

The dynamic information 130 may be information to be used for modeling the application 110. The dynamic information 130 may include information about the execution process of the binary file. For example, the dynamic information 130 may include a function call stack (or a function call path), a core branch (or a core path, a core function call stack, or a core function call path), a function instruction overhead (or an overhead occurring during the simulation of the application 110), and a function input parameter (or metadata of a function).

The DBA framework may include a plug-in tool, a just-in-time (JIT) compiler, and a simulation module. The DBA framework may be a program to perform DBA on the application 110.

The binary file of the application 110 may be executed through the simulation module in the DBA framework. The binary file of the application 110 may be converted into disassembly code by machine code during simulation. The plug-in tool may generate the machine code by performing code instrumentation on the disassembly code.

The plug-in tool may estimate the simulation overhead of the application 110 and detect the core branch through the code instrumentation.

The electronic device 100 may acquire the dynamic information 130, based on the execution of the binary file of the application 110. The electronic device 100 may determine a core function of the binary file of an application to be modeled. The core function may refer to a function with many workloads (e.g., having a workload exceeding a threshold value) among a plurality of functions (e.g., a plurality of functions performed during the execution process of the binary file). The electronic device 100 may determine whether to call the core function of the binary file of the application 110. The electronic device 100 may set one or more simulation schedules for the binary file, based on whether to call the core function.

The electronic device 100 may execute the binary file in parallel according to the one or more simulation schedules and acquire the dynamic information 130 (e.g., a function instruction overhead during simulation, a core function call path, and timing information related to a function call of the binary program). The electronic device 100 may estimate the function instruction overhead and generate the dynamic information 130 by detecting the function call core path, based on the execution of the application 110.

The electronic device 100 may determine at least one core function among the plurality of functions. The electronic device 100 may analyze a workload of the plurality of functions. The electronic device 100 may determine, to be the core function, among the plurality of functions, a function of which a workload exceeds a threshold value (e.g., a threshold value set by the electronic device 100 or a user). The core function may be determined to be at least one function.

The electronic device 100 may determine whether to call the core function. The calling of the core function may refer to calling a core function to be performed when the binary file of the application 110 is executed. When calling one of one or more core functions, the electronic device 100 may determine not to call other core functions except for the called core function. This may be to perform only one of a plurality of call functions when the binary file is executed. For example, when calling a first core function, which is one of the one or more core functions, the electronic device 100 may not call, among the one or more core functions, other core functions except for the first core function.

The electronic device 100 may set the one or more simulation schedules for the binary file, based on whether to call the core function. The one or more simulation schedules may be set to execute the binary file by performing only the called core function. For example, in whether to call the core function, it may be determined to call the first core function and not to call other core functions except for the first core function, as described above. When calling the first core function and not calling other core functions except for the first core function, the electronic device 100 may generate a first simulation schedule that maintains the execution of the first core function and blocks the execution of the other core functions. The electronic device 100 may block an uncalled core function of the core function of the binary file of the application 110 through a wrapper library. Through the maintaining of the execution of only the called core function, electronic device 100 of one or more embodiments may enable quick stacking and call analysis of a function, thereby reducing the time overhead of DBA and significantly shortening the application modeling time.

The electronic device 100 may generate the dynamic information 130 by executing the binary file in parallel according to the one or more simulation schedules. For example, the first simulation schedule corresponding to a case in which the first core function is called and a second simulation schedule corresponding to a case in which a second core function is called may be generated. The electronic device 100 may execute the binary file in parallel according to the first simulation schedule and the second simulation schedule. For example, the electronic device 100, according to the first simulation schedule, may execute the binary file by maintaining the execution of the first core function and blocking (e.g., performed by the wrapper library) the execution of other core functions except for the first core function. In addition, the electronic device 100 may execute the binary file by maintaining the execution of the second core function and blocking (e.g., performed by the wrapper library) the execution of other core functions except for the second core function according to the second simulation schedule performed in parallel with the execution of the binary file according to the first simulation schedule.

The electronic device 100 may perform DBA on the result obtained by executing the binary file of the application 110 and acquire function metadata of the core function. For example, the electronic device 100 may acquire the function metadata of each core function by maintaining only one core function in each DBA process through function-level modeling (e.g., setting a simulation schedule according to whether to call the core function).

The electronic device 100 may acquire the dynamic information 130 by performing DBA on the execution process of the binary file (e.g., a parallel execution process according to a simulation schedule) of the application 110. The electronic device 100 may extract the dynamic information 130 during the execution of the binary file of the application 110 through DBA technology such that the application modeling process may not depend on the source code of the application 110.

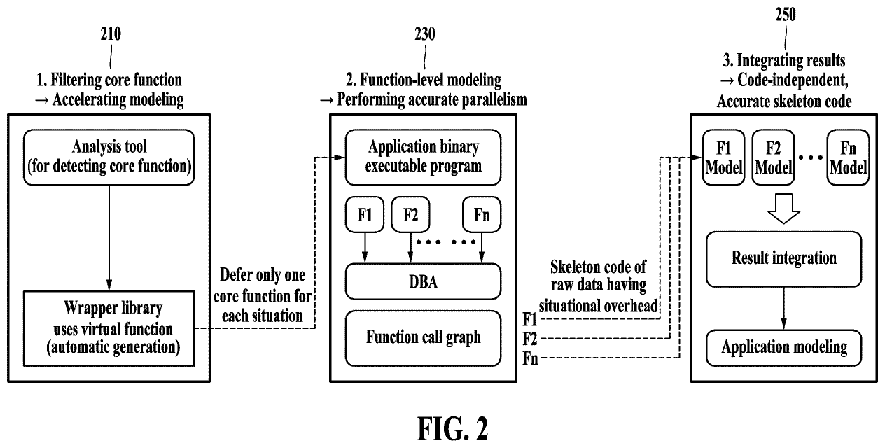

FIG. 2 illustrates an example of accelerating a DBA process by performing function-level modeling at a high speed through a wrapper library.

Referring to FIG. 2, operations 210 to 250 may be performed sequentially but not necessarily. For example, the order of operations 210 to 250 may be changed, one or more of the operations may be omitted, and/or at least two of operations 210 to 250 may be performed in parallel or simultaneously without departing from the spirit and scope of the example embodiments described herein.

In operation 210, an electronic device (e.g., the electronic device 100 of FIG. 1) may perform core function filtering. The electronic device 100 may determine a core function of the binary file of the application 110 through an analysis tool. The electronic device 100 may accelerate modeling of an application (e.g., the application 110 of FIG. 1) through a core function filter.

The electronic device 100 may generate a hijacking function (e.g., a virtual function of FIG. 2) and store the hijacking function in a wrapper library. The electronic device 100 may perform precise function-level modeling in parallel on the application 110 by the hijacking function deferring at least one core function (e.g., at least one of functions F1 to Fn) in each DBA process (e.g., operation 210 of filtering a core function, operation 230 of a function-level modeling, and/or operation 250 of integrating results).

The electronic device 100 may configure the wrapper library to accelerate DBA. In the process of rapidly performing function-level modeling through the wrapper library and accelerating the DBA process, the electronic device 100 may first determine the core function of the binary program of an application to be modeled by the analysis tool and then accelerate modeling using the core function as the core function filter.

In operation 230, the electronic device 100 may perform function-level modeling. The electronic device 100 may rapidly perform function-level modeling through the wrapper library and accelerate the DBA process (e.g., operation 210 of filtering the core function, operation 230 of the function-level modeling, and operation 250 of integrating the results).

The electronic device 100 may determine a core function to be performed (or called) in a simulation schedule through the hijacking function of the wrapper library. In one or more simulations, the electronic device 100 may realize the modeling of a single core function by maintaining the execution of one core function and blocking the execution of other core functions. The electronic device 100 of one or more embodiments may greatly improve the efficiency of DBA through modeling of the single core function.

The electronic device 100 may acquire a call structure for a call relationship between a plurality of functions performed during the execution process of the binary file of the application 110, based on dynamic information (e.g., the dynamic information 130 of FIG. 1) (e.g., dynamic information acquired through modeling of the single core function based on the hijacking function). The electronic device 100 may parse the dynamic information 130. The electronic device 100 may generate (e.g., construct) a tree diagram representing the call structure for the call relationship between the plurality of functions, based on the result obtained by parsing the dynamic information 130. Since the dynamic information 130 includes timing information related to a function call of the binary file, a tree diagram of the function call may be constructed as a function call stack expanded for each layer. In the typical DBA process, when the same function is called multiple times, the call stack may overlap. In contrast, by performing modeling on the single core function based on the hijacking function, when the same function is called multiple times, the electronic device 100 of one or more embodiments may advantageously expand the called stack.

In operation 250, the electronic device 100 may integrate the results of models of the core function and generate skeleton code of the application 110 that does not depend on the source code of the application 110.

The tree diagram representing the call structure for the call relationship of the plurality of functions may include skeleton code of original data having situational overhead. The electronic device 100 may acquire models (e.g., model F1 to model Fn) of each core function (e.g., function F1 to function Fn), based on the tree diagram, and may generate the skeleton code that does not depend on the source code of the application 110 by integrating the results of the models of the core function.

FIG. 3 illustrates an example of a hijacking function in a wrapper library.

Referring to FIG. 3, an electronic device (e.g., the electronic device 100 of FIG. 1) may acquire one or more core functions 330 (e.g., function F1 to function Fn) through an analysis tool 310.

The analysis tool 310 may determine the one or more core functions 330 among a plurality of functions (e.g., performed during the execution process of a binary file of an application (e.g., the application 110 of FIG. 1). The analysis tool 310 may analyze a workload of the plurality of functions. The analysis tool 310 may determine, to be a core function 330 (e.g., function F1 to function Fn), among the plurality of functions, at least one function of which a workload exceeds a threshold value when the binary file is executed.

The electronic device 100 may generate a hijacking function 350 in a wrapper library 370 for the one or more core functions 330. The electronic device 100 may activate the hijacking function 350 through a setting. When the hijacking function 350 is activated, the electronic device 100 may set a simulation schedule to execute the binary file through the hijacking function 350. For example, when a first core function (e.g., the function F1) is called and other core functions (e.g., the function F2 to the function Fn) are not called, the electronic device 100 may maintain the execution of the function F1 and block the execution of the function F2 to the function Fn. The electronic device 100 may block the execution of the function F2 to the function Fn through the hijacking function 350 that is activated. A method of setting a simulation schedule when other core functions (e.g., the function F2 to the function Fn) are called is substantially the same as when the function F1 is called, so a repeated description thereof is omitted.

The electronic device 100 of one or more embodiments may significantly improve the efficiency of DBA by maintaining the execution of only a single core function.

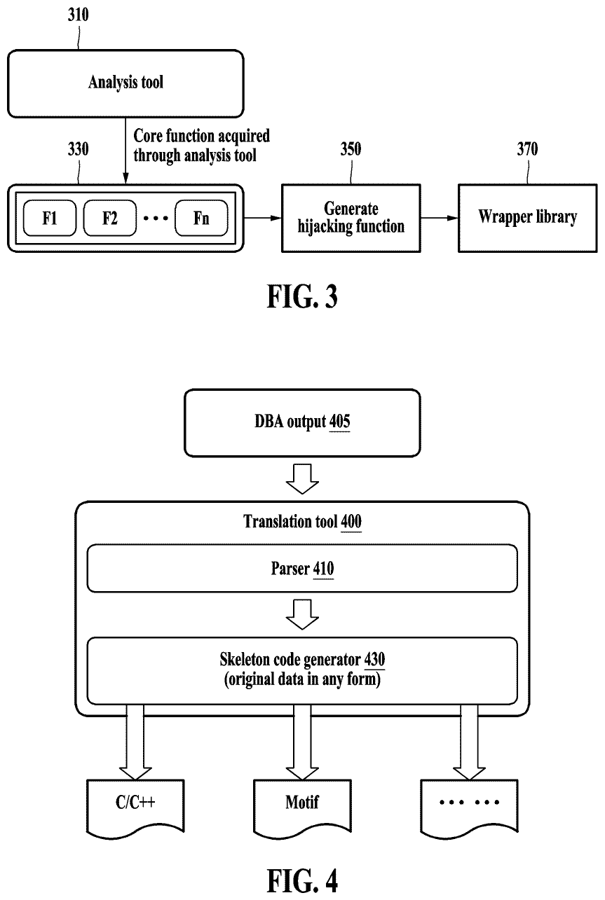

FIG. 4 illustrates an example of a translation tool.

Referring to FIG. 4, an electronic device (e.g., the electronic device 100 of FIG. 1) may process a result of a DBA output 405 through a translation tool 400 and generate skeleton code of an application (e.g., the application 110 of FIG. 1). The translation tool 400 may process (and/or analyze) the result of the DBA output 405 (e.g., dynamic information (e.g., the dynamic information 130 of FIG. 1) about the execution process of the binary file of the application 110) and generate the skeleton code of the application 110. The translation tool 400 may generate pieces of application skeleton code of various types of language using the dynamic information 130 generated through DBA and realize application modeling.

The translation tool 400 may include a parser 410 and a skeleton code generator 430. Hereinafter, example operations of the parser 410 and the skeleton code generator 430 are described in detail.

The parser 410 may analyze the result of the DBA output 405 (e.g., the dynamic information 130). The parser 410 may acquire a call structure for a call relationship between a plurality of functions performed during the execution process of the binary file, based on the dynamic information 130. The parser 410 may parse the dynamic information 130 and generate a function call structure (e.g., a tree diagram representing the call structure for the call relationship between the plurality of functions) for the execution process of the binary file.

The skeleton code generator 430 may generate the skeleton code of the application 110, based on the call structure for the call relationship between the plurality of functions. The skeleton code generator 430 may generate the skeleton code for each layer (or level) according to a language that is designated for the application 110, based on the tree diagram representing the call structure for the call relationship between the plurality of functions. The designated language may be, for example, C/C++, Motif, and/or other machine languages but is not limited thereto.

The tree diagram representing the call structure for the call relationship between the plurality of functions may include skeleton code of original data having situational overhead. The skeleton code generator 430 may acquire the models (e.g., the model F1 to the model Fn) of each core function (e.g., the function F1 to the function Fn), based on the tree diagram, and may generate the skeleton code that does not depend on the source code of the application 110 by integrating the results of the models of the core function.

The application modeling method may replace a process of analyzing the source code with the extraction of the dynamic information 130 during the execution of the binary file of the application 110 through DBA. By replacing the source code analysis with the extraction of the dynamic information 130 according to DBA, the DBA results according to the core function may be integrated, and thus an application modeling method of one or more embodiments advantageously may not depend on the source code of the application 110.

The application modeling method of one or more embodiments may significantly reduce the application modeling time by suggesting a solution (e.g., performing parallel simulation according to the modeling of a single core function) for reducing the DBA time overhead.

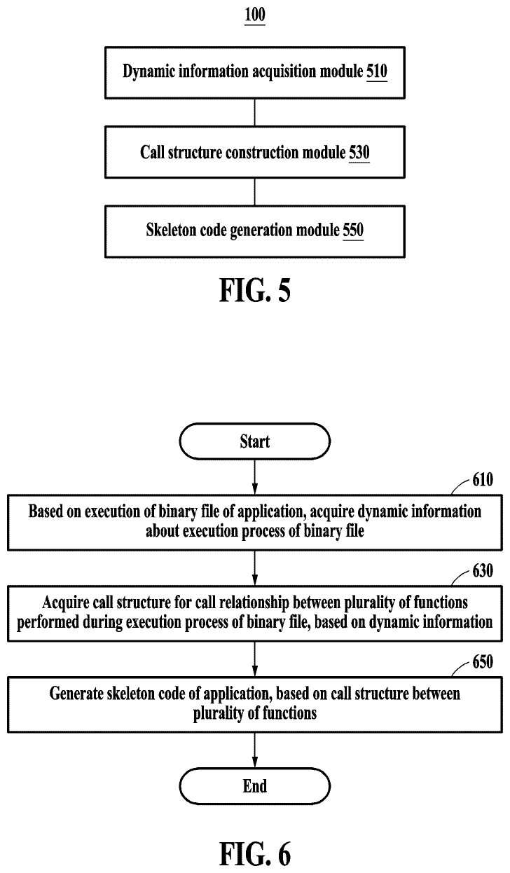

FIG. 5 illustrates an example of an application modeling apparatus.

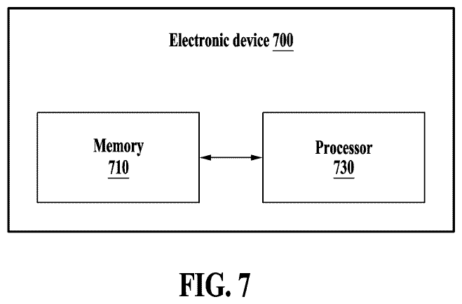

Referring to FIG. 5, an electronic device (e.g., the electronic device 100 of FIG. 1) may include a dynamic information acquisition module 510, a call structure construction module 530, and a skeleton code generation module 550. The dynamic information acquisition module 510, the call structure construction module 530, and the skeleton code generation module 550 may be implemented as one processor or a plurality of processors (e.g., a processor 730 of FIG. 7).

The dynamic information acquisition module 510 may acquire dynamic information (e.g., the dynamic information 130 of FIG. 1), based on the execution of a binary file of an application (e.g., the application 110 of FIG. 1). The dynamic information acquisition module 510 may perform DBA during the execution of the binary file of the application 110. The dynamic information acquisition module 510 may generate the dynamic information, based on the result obtained by performing DBA.

The dynamic information acquisition module 510 may analyze a workload of each function of the binary file of the application 110 and determine, to be a core function, at least one function of which a workload exceeds a threshold value.

The dynamic information 130 may include timing information related to a function call of the binary file, the overhead of the execution process, and/or a core function call path. The dynamic information acquisition module 510 may determine the core function of the binary file of the application 110. The dynamic information acquisition module 510 may determine whether to call the core function. The dynamic information acquisition module 510 may set a simulation schedule, based on whether to call the core function. The dynamic information acquisition module 510 may execute (e.g., perform the execution of the binary file according to a first simulation schedule and the execution of the binary file according to a second simulation schedule in parallel) the binary file in parallel according to the simulation schedule, thereby acquiring the overhead of the execution process, the core function call path, and the timing information related to the function call of the binary file.

The dynamic information acquisition module 510 may block, among core functions, the execution of an uncalled core function of the binary file of the application 110 through a wrapper library.

The dynamic information 130 may further include function metadata of the core function. The dynamic information acquisition module 510 may block the uncalled core function, based on a hijacking function of the wrapper library. The dynamic information acquisition module 510 may determine function metadata of a called core function by executing only the called core function. By performing at least one simulation schedule in parallel, the dynamic information acquisition module 510 may determine the function metadata of the core function performed in each simulation schedule.

The call structure construction module 530 may acquire call structure information about a call relationship between a plurality of functions performed during the execution of the binary file of the application 110, based on the dynamic information 130.

The call structure construction module 530 may parse the dynamic information 130. The call structure construction module 530 may construct a tree diagram representing the call structure between the plurality of functions during the execution of the binary file of the application 110, based on the result obtained by parsing the dynamic information 130.

The skeleton code generation module 550 may generate skeleton code for each layer (or level) according to a language that is designated for the application 110, based on the tree diagram representing the call structure between the plurality of functions.

FIG. 6 illustrates an example of an application modeling method.

Referring to FIG. 6, operations 610 to 650 may be performed sequentially but are not limited thereto. For example, the order of operations 210 to 250 may be changed, one or more of the operations may be omitted, and/or two or more operations may be performed in parallel or simultaneously without departing from the spirit and scope of the example embodiments described herein. Operations 610 to 650 may be substantially the same as the operations of an electronic device (e.g., the electronic device 100 of FIG. 1) described with reference to FIGS. 1 to 5. Accordingly, a repeated description thereof is omitted.

In operation 610, based on the execution of a binary file of an application (e.g., the application 110 of FIG. 1), the electronic device 100 may acquire dynamic information (e.g., the dynamic information 130 of FIG. 1) about the execution process of the binary file.

The electronic device 100 may determine, among a plurality of functions, one or more core functions performed during the execution process of the binary file. The electronic device 100 may analyze a workload of the plurality of functions. The electronic device 100 may determine, to be a core function, among the plurality of functions, at least one function of which a workload exceeds a threshold value when the binary file is executed.

The electronic device 100 may determine whether to call the one or more core functions. When calling a first core function, which is one of the one or more core functions, the electronic device 100 may determine, among the one or more core functions, not to call other core functions except the first core function.

The electronic device 100 may set one or more simulation schedules for the binary file, based on whether to call the one or more core functions. When the first core function is called and other core functions except the first core function are not called, the electronic device 100 may generate a first simulation schedule that maintains the execution of the first core function and blocks the execution of other core functions except the first core function. Although the first core function is described, simulation schedules may be set for all other core functions except for the first core function. Like the first simulation schedule, each simulation schedule may maintain the execution of one core function and block the execution of other core functions.

The electronic device 100 may execute the binary file in parallel according to the one or more simulation schedules and generate the dynamic information 130. The electronic device 100 may perform DBA on the result obtained by executing the binary file in parallel and generate the dynamic information 130.

In operation 630, the electronic device 100 may acquire a call structure for a call relationship between a plurality of functions performed during the execution process of the binary file, based on the dynamic information 130.

The electronic device 100 may parse the dynamic information 130. The electronic device 100 may generate a tree diagram representing the call structure for the call relationship between the plurality of functions during the execution of the binary file, based on the result obtained by parsing the dynamic information 130.

In operation 650, the electronic device 100 may generate skeleton code of the application 110, based on the call structure for the call relationship between the plurality of functions.

The electronic device 100 may generate the skeleton code for each layer according to a language that is designated for the application 110, based on the tree diagram representing the call structure for the call relationship between the plurality of functions.

FIG. 7 illustrates an example of an electronic device.

Referring to FIG. 7, an electronic device 700 may include a memory 710 (e.g., one or more memories) and a processor 730 (e.g., one or more processors). The electronic device 700 may include the electronic device 100 of FIG. 1.

The memory 710 may store instructions (or programs) executable by the processor 730. For example, the instructions may include instructions for performing an operation of the processor 730 and/or an operation of each component of the processor 730. For example, the memory 710 may be or include a non-transitory computer-readable storage medium storing instructions that, when executed by the processor 730, configure the processor 730 to perform any one, any combination, or all of the operations and/or methods discussed above with reference to FIGS. 1-6.

The memory 710 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), a resistive RAM (RRAM), a nanotube RRAM, a polymer RAM (PoRAM), nano floating gate memory (NFGM), holographic memory, a molecular electronic memory device, or insulator resistance change memory.

The processor 730 may process data stored in the memory 710. The processor 730 may execute computer-readable code (e.g., software) stored in the memory 710 and instructions triggered by the processor 730.

The processor 730 may be a data-processing device implemented by hardware having a circuit of a physical structure to execute desired operations. For example, the desired operations may include code or instructions in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 730 may cause the electronic device 700 to perform one or more operations by executing the code and/or instructions stored in the memory 710. The operations performed by the electronic device 700 may be substantially the same as the operations performed by the electronic device 100 described with reference to FIGS. 1 to 6. Accordingly, a repeated description thereof is omitted.

The electronic devices, analysis tools, translation tools, parsers, skeleton code generators, dynamic information acquisition modules, call structure construction modules, skeleton code generation modules, memories, processors, electronic device 100, analysis tool 310, translation tool 400, parser 410, skeleton code generator 430, dynamic information acquisition module 510, call structure construction module 530, skeleton code generation module 550, electronic device 700, memory 710, and processor 730 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
based on an execution of a binary file of an application, acquiring dynamic information about an execution process of the binary file;
acquiring a call structure for a call relationship between a plurality of functions performed in the execution process of the binary file, based on the dynamic information; and
generating skeleton code of the application, based on the call structure for the call relationship between the plurality of functions.

2. The method of claim 1, wherein the acquiring of the dynamic information comprises:
determining one or more core functions among the plurality of functions, wherein the one or more core functions have a workload exceeding a threshold value, among the plurality of functions;
determining whether to call the one or more core functions;
setting one or more simulation schedules for the binary file, based on a result of the determining of whether to call the one or more core functions; and
generating the dynamic information by executing the binary file in parallel according to the set one or more simulation schedules.

3. The method of claim 2, wherein the determining of the one or more core functions among the plurality of functions comprises:
analyzing one or more workloads of the plurality of functions; and
determining, to be the one or more core functions, among the plurality of functions, one or more functions of which a workload of the one or more workloads exceeds the threshold value in response to the binary file being executed.

4. The method of claim 2, wherein the determining of whether to call the one or more core functions comprises, in response to calling a first core function, which is one of the one or more core functions, determining, among the one or more core functions, not to call another core function except for the first core function.

5. The method of claim 4, wherein the setting of the one or more simulation schedules comprises, in response to calling the first core function and not calling the other core function except for the first core function, generating a first simulation schedule configured to maintain an execution of the first core function and configured to block an execution of the other core function except for the first core function.

6. The method of claim 5, wherein the blocking of the execution of the other core function is performed through a wrapper library.

7. The method of claim 6, wherein the blocking of the execution of the other core function comprises hijacking the other core function based on a hijacking function of the wrapper library.

8. The method of claim 2, wherein the generating of the dynamic information by executing the binary file in parallel comprises generating the dynamic information by performing dynamic binary analysis (DBA) on a result obtained by executing the binary file in parallel.

9. The method of claim 1, wherein the acquiring of the call structure for the call relationship between the plurality of functions comprises:
parsing the dynamic information; and
generating a tree diagram representing the call structure for the call relationship between the plurality of functions during the execution of the binary file, based on a result obtained by parsing the dynamic information.

10. The method of claim 9, wherein the generating of the skeleton code of the application comprises generating the skeleton code for each layer according to a language that is designated for the application, based on the tree diagram representing the call structure for the call relationship between the plurality of functions.

11. An electronic device comprising:
one or more processors configured to:
based on an execution of a binary file of an application, acquire dynamic information about an execution process of the binary file;
acquire a call structure for a call relationship between a plurality of functions performed in the execution process of the binary file, based on the dynamic information; and
generate skeleton code of the application, based on the call structure for the call relationship between the plurality of functions.

12. The electronic device of claim 11, wherein, for the acquiring of the dynamic information, the one or more processors are configured to:
determine one or more core functions among the plurality of functions, wherein the one or more core functions have a workload exceeding a threshold value, among the plurality of functions;
determine whether to call the one or more core functions;
set one or more simulation schedules for the binary file, based on a result of the determining of whether to call the one or more core functions; and
generate the dynamic information by executing the binary file in parallel according to the set one or more simulation schedules.

13. The electronic device of claim 12, wherein, for the determining of the one or more core functions among the plurality of functions, the one or more processors are configured to:
analyze one or more workloads of the plurality of functions; and
determine, to be the one or more core functions, among the plurality of functions, one or more functions of which a workload of the one or more workloads exceeds the threshold value in response to the binary file being executed.

14. The electronic device of claim 12, wherein, for the determining of whether to call the one or more core functions, the one or more processors are configured to, in response to calling a first core function, which is one of the one or more core functions, determine, among the one or more core functions, not to call another core function except for the first core function.

15. The electronic device of claim 14, wherein, for the setting of the one or more simulation schedules, the one or more processors are configured to, in response to calling the first core function and not calling the other core function except for the first core function, generate a first simulation schedule configured to maintain an execution of the first core function and configured to block an execution of the other core function except for the first core function.

16. The electronic device of claim 15, wherein the blocking of the execution of the other core function is performed through a wrapper library.

17. The electronic device of claim 16, wherein the blocking of the execution of the other core function comprises hijacking the other core function based on a hijacking function of the wrapper library.

18. The electronic device of claim 12, wherein, for the generating of the dynamic information by executing the binary file in parallel, the one or more processors are configured to generate the dynamic information by performing dynamic binary analysis (DBA) on a result obtained by executing the binary file in parallel.

19. The electronic device of claim 11, wherein, for the acquiring of the call structure for the call relationship between the plurality of functions, the one or more processors are configured to:
parse the dynamic information; and
generate a tree diagram representing the call structure for the call relationship between the plurality of functions during the execution of the binary file, based on a result obtained by parsing the dynamic information.

20. The electronic device of claim 19, wherein, for the generating of the skeleton code of the application, the one or more processors are configured to generate the skeleton code for each layer according to a language that is designated for the application, based on the tree diagram representing the call structure for the call relationship between the plurality of functions.
